(19) United States
(12) Patent Application Publication
(10) Pub. No.: US 2006/0271920 A1
(43) Pub. Date: Nov. 30, 2006

(54) MULTILINGUAL COMPILER SYSTEM AND METHOD

(76) Inventor: Wael Abouelsaadat, Toronto (CA)

Correspondence Address: WAEL ABOUELSAADAT, 280 WELLESLEY ST. EAST APT.3216, TORONTO, ON, M4X 1G7, CA

(21) Appl. No.: 11/420,009

(22) Filed: May 24, 2006

Related U.S. Application Data
(60) Provisional application No. 60/683,807, filed on May 24, 2005.

(51) Int. Cl. G06F 9/45

(52) U.S. Cl. 717/137

(57) ABSTRACT

A method and system are provided for creating multilingual computer programs. Programmers use their own native language in writing software instructions and commands and the invention translates those either to another native language or to a native-language-independent representation. The invention supports having a single computer program with multiple native languages.

### CROSS-REFERENCE TO RELATED APPLICATIONS

This application claims the benefit of Provisional Patent Application Ser. No. U.S. 60/683,807, filed May 24, 2005 by the present inventor.

### CUSTOMER NUMBER

42414

### FEDERALLY SPONSERED RESEARCH

Not Applicable

### SEQUENCE LISTING OR PROGRAM

Not Applicable

### BACKGROUND OF THE INVENTION

1. Field of the Invention

This invention relates to compilers and translators for digital computer systems, and more particularly to a multilingual programming method and system that is used in a multilingual computer language and also relates to multilingual software development, and more specifically to translating portions or all of a program source file.

2. Background Description

Programming languages use English-like words to represent computer instructions, and to output errors and warnings. Although, programming as an activity is independent of human-languages (e.g. English), yet programmers have to be competent in the used human-language to be able to create and maintain programs, understand compiler/interpreter errors and warnings, comprehend language documentation and use the provided language software tools. This dependency on a single human-language, whether English or otherwise, creates an unnecessary barrier for programmers whose native languages are different.

U.S. Pat. No 6,035,121 and U.S. Pat. No. 6,735,759 describe methods for translating a program's output and input messages to support localization. U.S. Pat. No. 6,115,550 and U.S. Pat. No. 6,658,656 describe methods for replacing program fragment by another fragment more suitable to the underlying computer architecture. U.S. Pat. No. 6,202,201 and U.S. Pat. No. 6,286,133 describe methods for replacing text strings in a program by another text strings to support translating an input source program in one programming language to another source program in a different programming language with a different syntax. However, none of the previous works provide a multi-lingual programming method whereby the programming language vocabulary itself is multi-lingual whereby the source code of a program, or part thereof, can be written in any human language and can be translated completely, or part thereof, to another human language.

### SUMMARY OF THE INVENTION

It is an object of this invention to provide a multilingual programming method, which overcomes the human-language barrier created by having a programming-language syntax based on a specific human-language. Other objects are to minimize programmer's cognitive load and facilitate multilingual software development. Further objects and features of the invention will become apparent from a consideration of the ensuing description and drawing.

The present invention provides a novel method and system for creating multilingual computer programs. As used herein the term “human-language”, is used to refer to written and spoken native languages by humans, for example, English, French, or Japanese. The term “programming-language” is used to refer to languages used to instruct computers, for example, Java, Lisp, or C++. The term “programming-language” encompasses high level, as well as low-level computer languages and it also encompasses compiled and interpreted languages. The terms “human-language-like”, “programming-language-vocabulary” and “native-language” refer to the subset of a human-language that is used in the programming-language to facilitate communication between computers and humans. A “human-language-like” representation, “programming-language-vocabulary” or “native-language” include reserved words, keywords, operators, class names, object names, function names, macro names and other English-like words defined by the programming language designer. The term “human-language-independent” is used herein to encompass any language that is not a pure subset of a human-language. A “human-language-independent” representation denotes any sequence of alphanumeric codes, decimal numbers, hexadecimal numbers, symbols, or binary codes. The term “machine-language” or “target machine-language” is used herein to encompass any sequence of instructions intended to be executed directly by a physical or virtual processor. As used herein, the term “compiler” encompasses any software application used to translate a source language written in a human-language-like representation (e.g. English-like language) to a target machine-language. The term “identifier” is used herein to refer to a variable, constant, function, object, array, record, label, procedure, class or type in a programming-language.

The invention provides a system and a method for creating multilingual computer programs. The invention is readily adapted for use with different types of programming languages, for example C++, Java and Smalltalk.

In the invention, a programming language has several human-language-like representations. A programmer can choose a human-language-like representation that derives or is close to her own native language. The invention comprises a bi-directional multilingual translator for translating an input source code program written in either a specific human-language-like representation or in a human-language-independent representation to a logically and semantically equivalent source code written in another human-language-like representation or in a human-language-independent representation.

### BRIEF DESCRIPTION OF THE DRAWINGS

For a further understanding of the objects, features and advantages of the present invention, reference should be had to the following description of the preferred embodiment, taken in conjunction with the accompanying drawing, in which like parts are given like reference numerals and wherein:

FIG. 1A is a block diagram showing architecture of a compiler;

FIG. 2B is a block diagram showing architecture of an interpreter;

FIG. 2A is a block diagram showing modified compiler architecture;

FIG. 2B is a block diagram showing modified interpreter architecture;

FIG. 3 is a block diagram of the invention's components is shown;

FIG. 4A is a representation of an exemplary multilingual terminals table;

FIG. 4B is a representation of an exemplary multilingual errors table;

FIG. 4C is a representation of an exemplary multilingual warnings table;

FIG. 5 depicts a detailed flow chart for a translating between a source and target native languages for the same programming language;

FIG. 6A is a block diagram showing usage of the invention;

FIG. 6B is a diagram showing an exemplary usage of the invention by a hypothetical programming-language;

FIG. 7A illustrates an alternative design of the invention to support multilingual programming;

FIG. 7B illustrates a usage of the alternative design of the invention to support multilingual programming;

### DETAILED DESCRIPTION OF THE INVENTION

The present invention now will be described hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

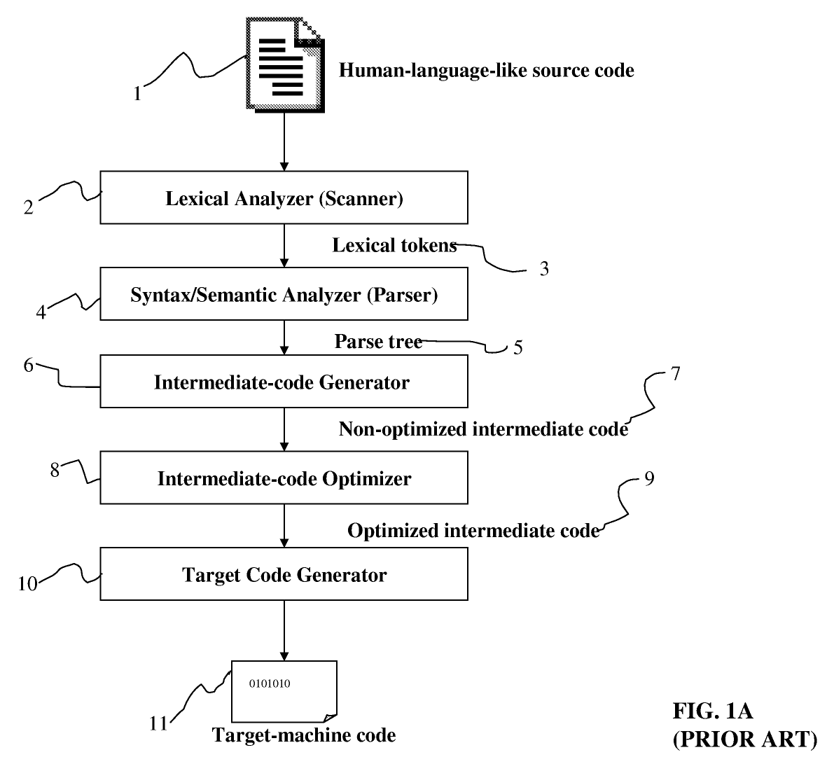

With reference now to the FIGS., and in particular with reference to FIG. 1A (prior art), a block diagram that illustrates the main components of a compiler is shown. A compiler is a computer program that read applications or programs written in a predetermined human-language-like representation, i.e., a source language, and convert the source language program to a second human-language-independent format. Additionally, a compiler typically performs other functions, such as reporting errors/warnings and importing other files and libraries for use by the source language file. The product of a compilation is typically a machine code language that can be executed directly or indirectly on a particular physical or virtual processor in a particular operating environment. The roles and functionalities of the compiler components are:

Lexical analyzer 2: lexical analysis involves breaking the source code text into small pieces called tokens 3 or terminals, each representing a single atomic unit of the language, for instance a keyword or an identifier.

Syntax/Semantic analyzer 4: syntax analysis involves identifying syntactic structures of source code. It only focuses on the structure. In other words, it identifies the order of tokens and understand hierarchical structures in code. This phase is also called parsing. Semantic analysis recognize the meaning of program code and start to prepare for output. In this phase, type checking is done and most of compiler errors show up. The output of this phase is a parse tree 5. Those familiar in the art will immediately recognize how a parse tree 5 is constructed from human-language-like source code 1.

Intermediate code generator 6: an equivalent to the original program 1 is created in a non-optimized intermediate code language 7.

Intermediate code optimizer 8: the intermediate code representation 7 is transformed into functionally equivalent but faster, or smaller, optimized intermediate code 9.

Target-code generator 10: the transformed intermediate code 9 is translated into the output target machine code 11, usually the native machine code of the system or that of a virtual machine. This involves resource and storage decisions, such as deciding which variables to fit into registers and memory and the selection and scheduling of appropriate machine instructions along with their associated addressing modes.

FIG. 1B shows a block diagram that illustrates the main components of an interpreter. An interpreter is a computer program that read programs written in one human-language-like source code 1, and executes it in a runtime environment 12.

Presently available compilers and interpreters (e.g. Java Interpreter, GNU compilers . . . ) may include additional functions not shown or may omit functions shown. The described architecture should not be considered as a limitation on the invention but merely as an exemplary of compilers and interpreters architecture.

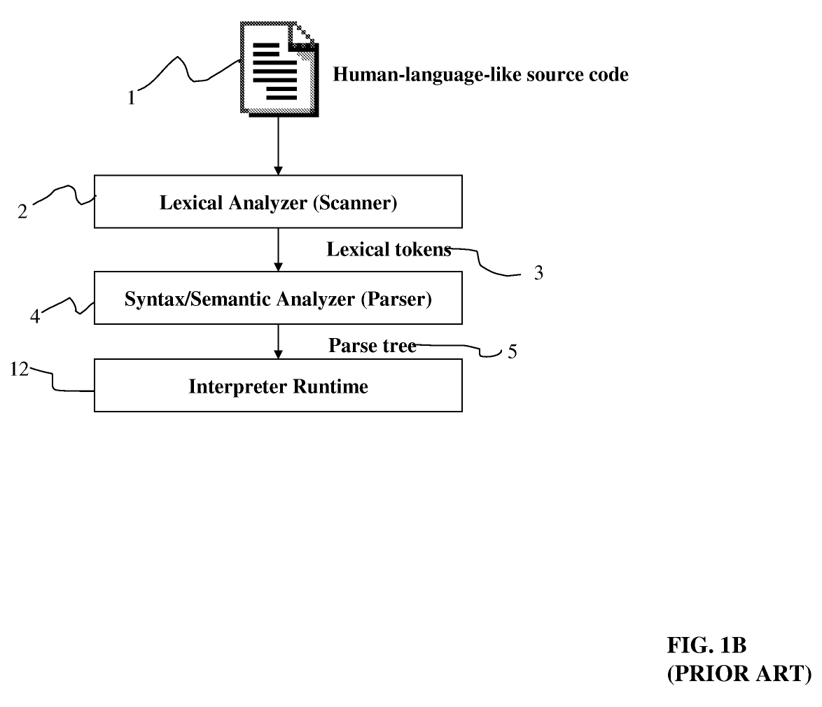

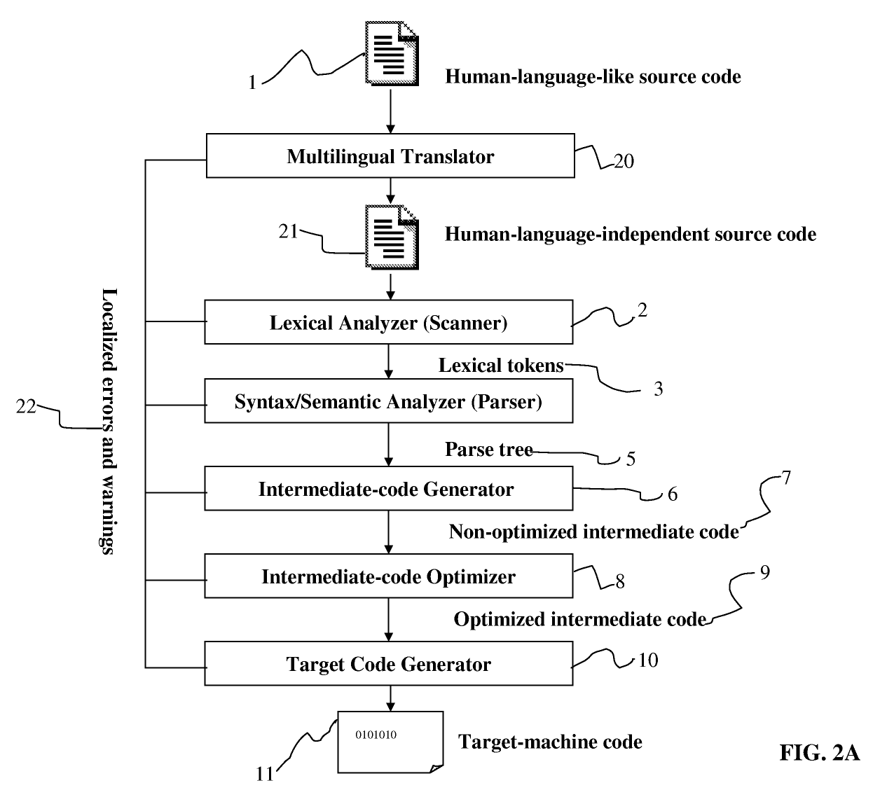

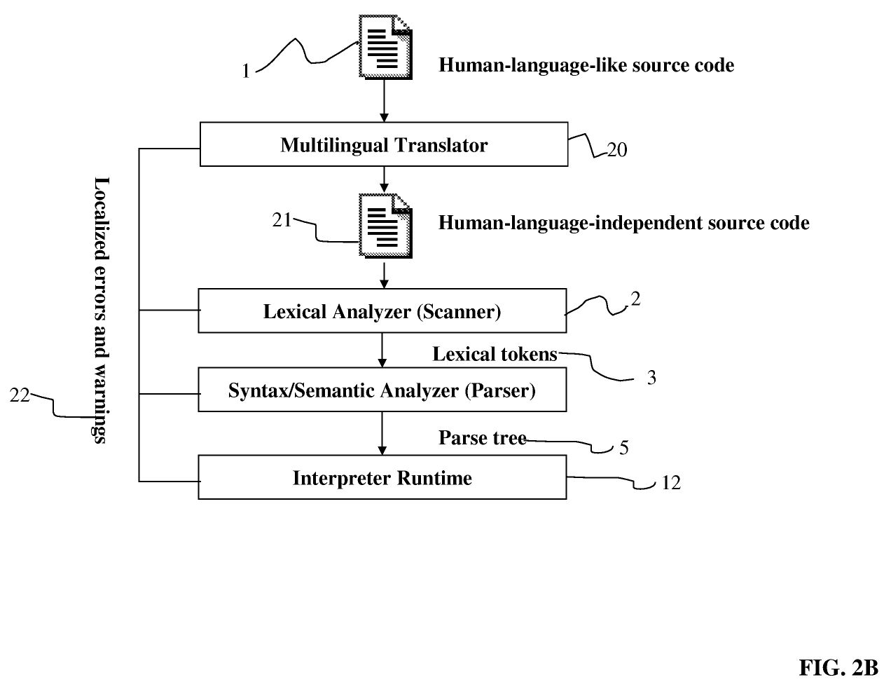

In FIG. 2A, a block diagram of modified compiler architecture, which includes the invention, is depicted. A multilingual translator 20 is used to translate a human-language-like source code 1 into a human-language-independent source code 21, which is next fed to the lexical analyzer 2. The lexical analyzer 2, syntax/semantic analyzer 4, intermediate code generator 6, intermediate code optimizer 8, and target code generator 10 have access to the multilingual translator 20, or parts there of, to be able to display errors and warnings 22 to the user in his/her preferred language.

In FIG. 2B, a block diagram of modified interpreter architecture, which includes the invention, is depicted. A multilingual translator 20 is used to translate a human-language-like source code 1 into a human-language-independent source code 21, which is next fed to the lexical analyzer 2. The lexical analyzer 2, syntax/semantic analyzer 4, and interpreter runtime 12 have access to the multilingual translator 20, or parts there of, to be able to display errors and warnings 22 to the user in his/her preferred language.

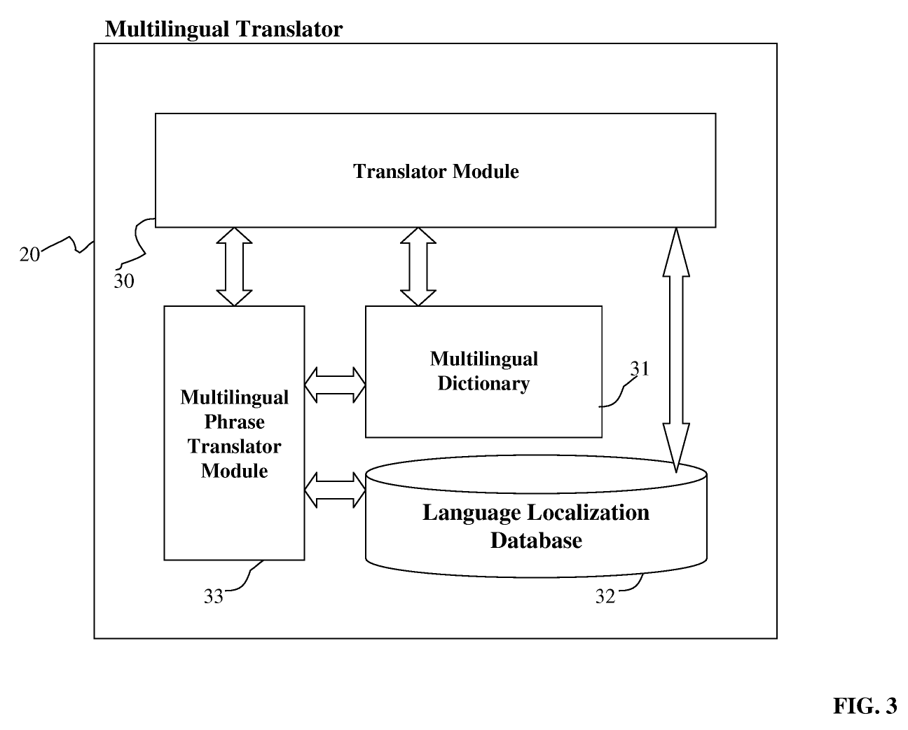

In FIG. 3, a block diagram of the invention's components is shown. A translator module 30 converts an input source code written in either a specific human-language-like representation or in a human-language-independent representation to a logically equivalent source code written in another human-language-like representation or to a human-language-independent representation. The translator module comprises a lexical analyzer that tokenizes a source input to produce tokens and a parser that determines relationships between the tokens. The translator module 30 utilizes a language localization database 32, which stores the human-language-like and equivalent human-language-independent representations. In addition, the translator 30 utilizes a multilingual dictionary module 21 to translate identifiers and utilizes a multilingual phrase translator module 33 to translate phrases written by the programmer as comments and documentation of the source code. The phrase translator module 33 internally uses software translation components such as those provided by www.tranexp.com. The multilingual dictionary module 21 internally use dictionary components such those provided by www.altavista.com babble-fish translation service.

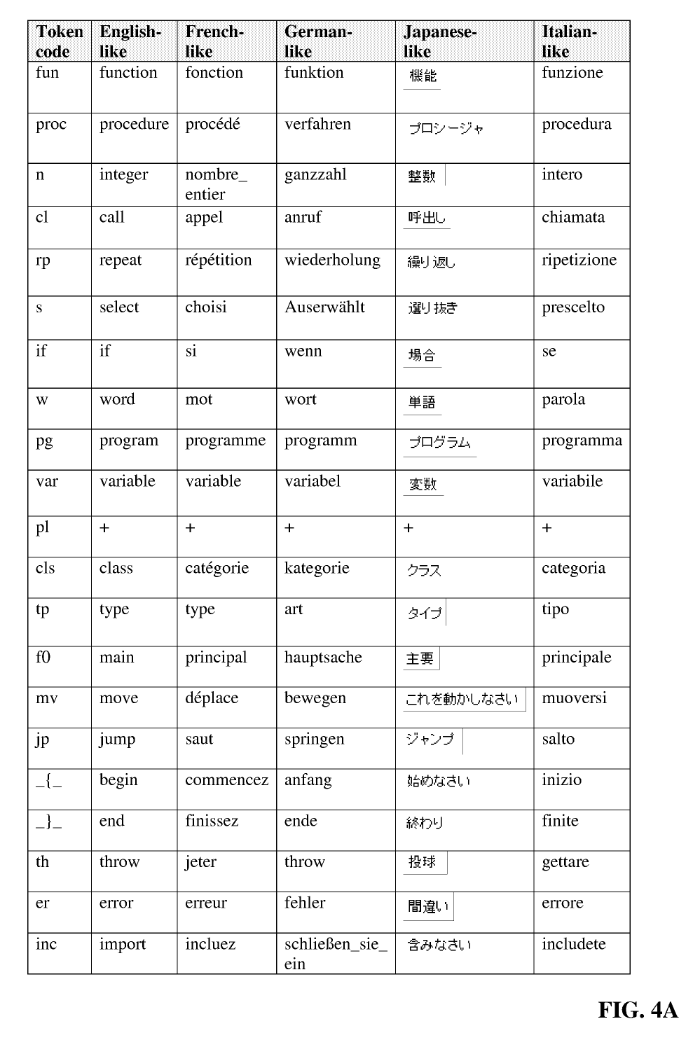

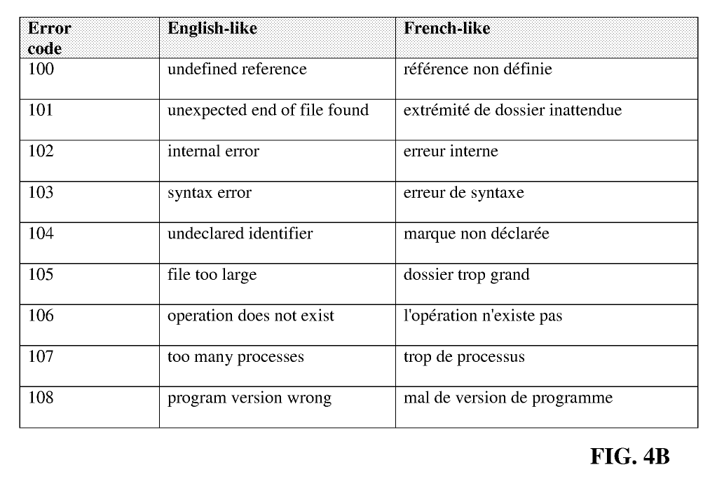

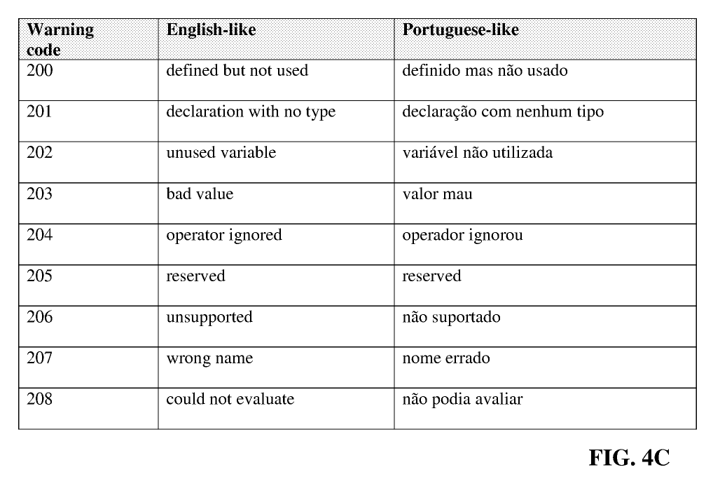

FIGS. 4A, 4B and 4C illustrate an exemplary language localization database 32 tables that are used by the multilingual translator module 30. FIG. 4A shows a table used in source code translation. The first column stores the code of a specific terminal while the remaining columns store the equivalent of that terminal in a particular human-language-like rendering. FIG. 4B shows a table used in compiler errors translation. The first column stores the code of a specific compiler error. The remaining columns store the equivalent of each error in a particular human-language-like rendering. FIG. 4C shows a table used in compiler warnings translation. The first column stores the code of a specific compiler warning. The remaining columns store the equivalent of the warning in a particular human-language-like rendering. Those skilled in the art will immediately recognize how to design a more efficient version of such database tables that could be used effectively by a database management system. The use of English, French, German, Italian, Portuguese and Japanese in FIGS. 4A, 4B and 4C is done for exemplary purposes only and is not meant to be a limitation upon the scope of the invention.

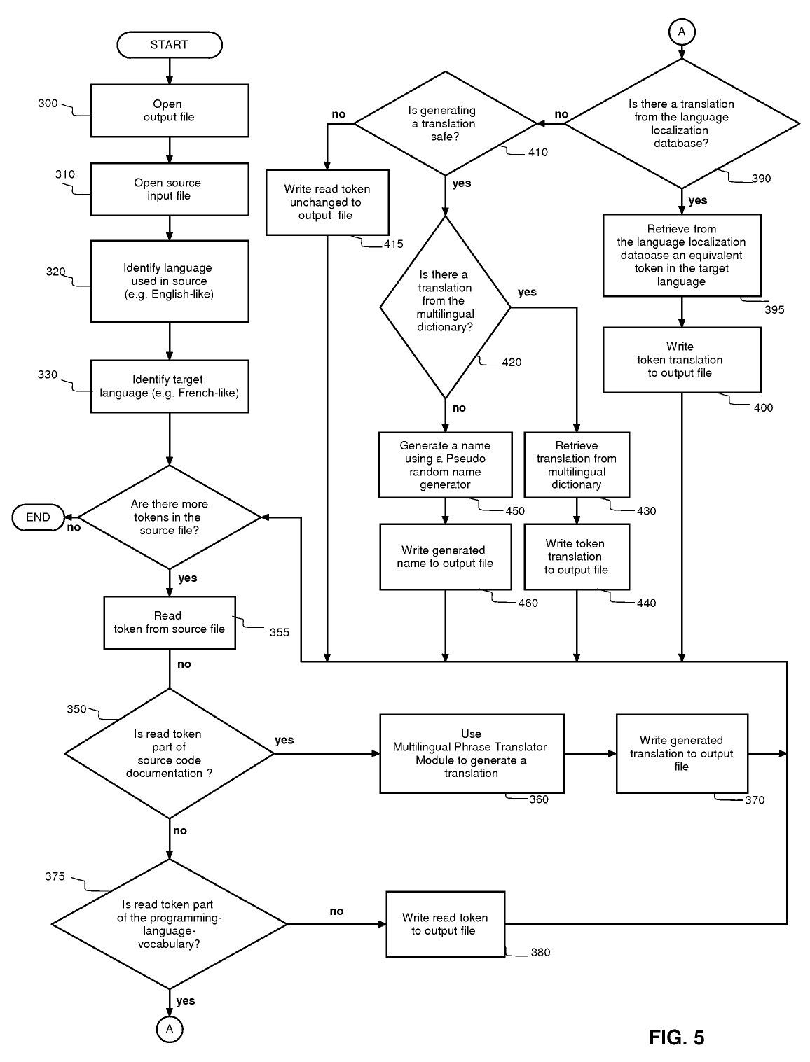

FIG. 5 depicts a detailed flow chart for translating between a source and target native languages for the same programming language. The multilingual translator starts by opening a file for writing (step 300) and a source input file to read from (step 310). The multilingual translator module identifies the human-language-like representation used either from the filename, extension, or using a meta tag defined in the source file or specified directly by the programmer (step 320). Similarly, the multilingual translator identifies the target human-language-like representation (step 330). Next, the multilingual translator module starts translating the source file (step 340) and writing the translation result to the output file. The source file is parsed into tokens. Those familiar in the art will immediately recognize how to build a parser for retrieving tokens from a given source. If the read token is part of a documentation (step 350), the whole phrase is passed to the multilingual phrase translator module (step 360) and the resulting translation is written to the output file (step 370). If the read token is not part of the programming-language-vocabulary (step 375), it is written unchanged to the output file (step 380). If the read token belongs to the programming-language-vocabulary (step 375), and there is a translation from the language localization database (step 390), the equivalent human-language-like token is retrieved from the language localization database (step 395) and written to the output file (step 400). If the read token does not belong to the programming-language-vocabulary (step 390), a check is made (step 410) to determine if it is safe to translate the token. If it is not safe to translate the token, it is written unchanged to the output file (step 415). An example of a token that will not be translated is the name of a function whose source code is not accessible. Translating such a function name will result in compilation and runtime errors, hence it must be avoided. If it is safe to translate the token (step 410), and there is a translation from the multilingual dictionary (step 420), the multilingual dictionary is searched for a translation (step 430) and if one is found, it is written to the output file (step 440). If there is no translation available from the multilingual dictionary (step 420), a pseudo random generator is used to generate a name in the target language (step 450) and the generated name is written to the output file (step 460). Table 1 shows an example of using XML tags to specify the native-language of the source code. Table 2 shows an example of using Meta properties to specify the native-language of the documentation.

TABLE 1
Using XML tags to specify native-language used in writing source code

```
<source-code language=English-like>
        .......
        .......
  </source-code>
  <code-source langue=Francais-comme>
        .......
        .......
</code-source>
<codice-sorgente lingua=italiano>
        .......
        .......
  </codice-sorgente>
```

TABLE 2
Using meta properties to specify native-language used in writing
documentation

```
/* !documentation-language = English-like
        .......
        .......
*/
  // !langue-de-documentation= Francais-comme
        .......
        .......
*/
  /* !lengua de la documentacion= espanol
        .......
        .......
*/
```

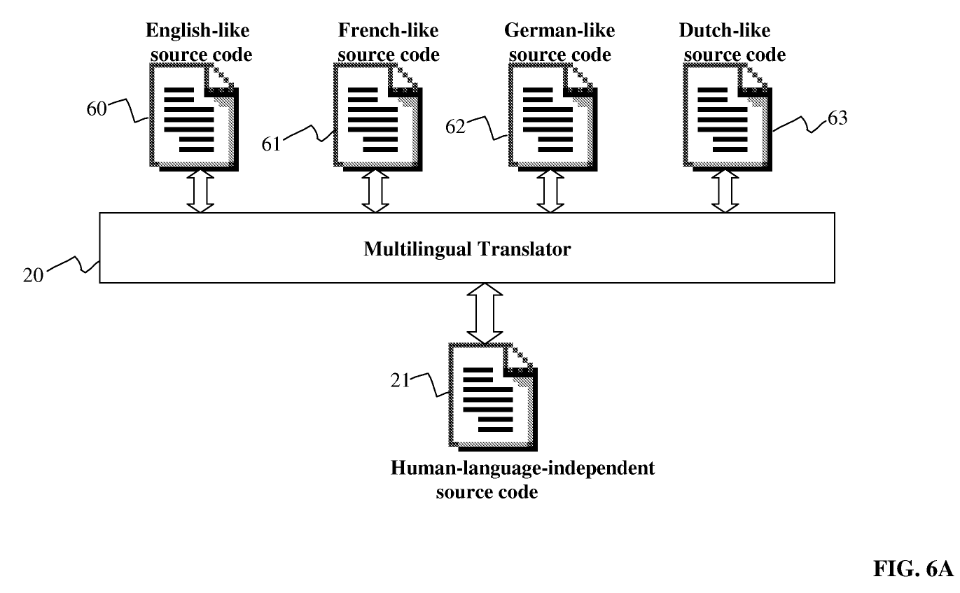

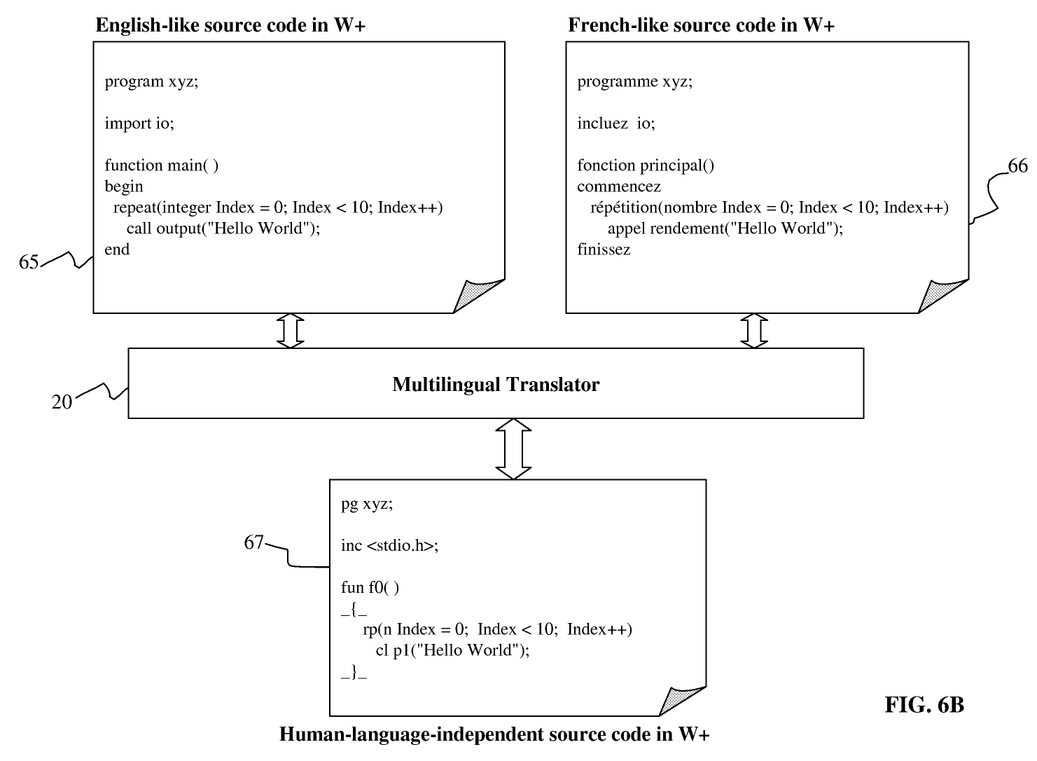

FIGS. 6A and 6B illustrate an exemplary usage of the multilingual translator. FIG. 6A illustrates that for any predetermined programming language (e.g. C++), programs written in one or more human-language-like representation 60, 61, 62, 63 could be created. Using the multilingual translator 20, these programs will all map to the same human-language-independent source code 21 and hence same logic. Similarly, a program stored in a human-language-independent language 21 could be mapped back to one or more human-language-like languages 60, 61, 62, 63. FIG. 6B illustrates an example of using the multilingual translator with a hypothetical language W+. The multilingual translator maps English-like source code in W+ 65 and French-like source code in W+ 66, to the same human-language-independent W+ source code 67.

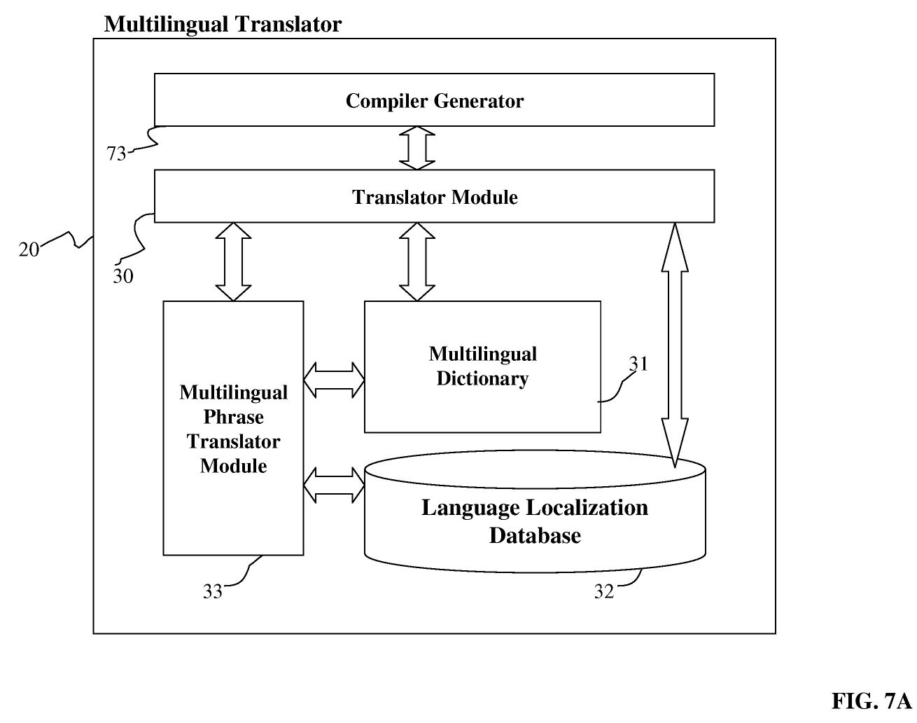

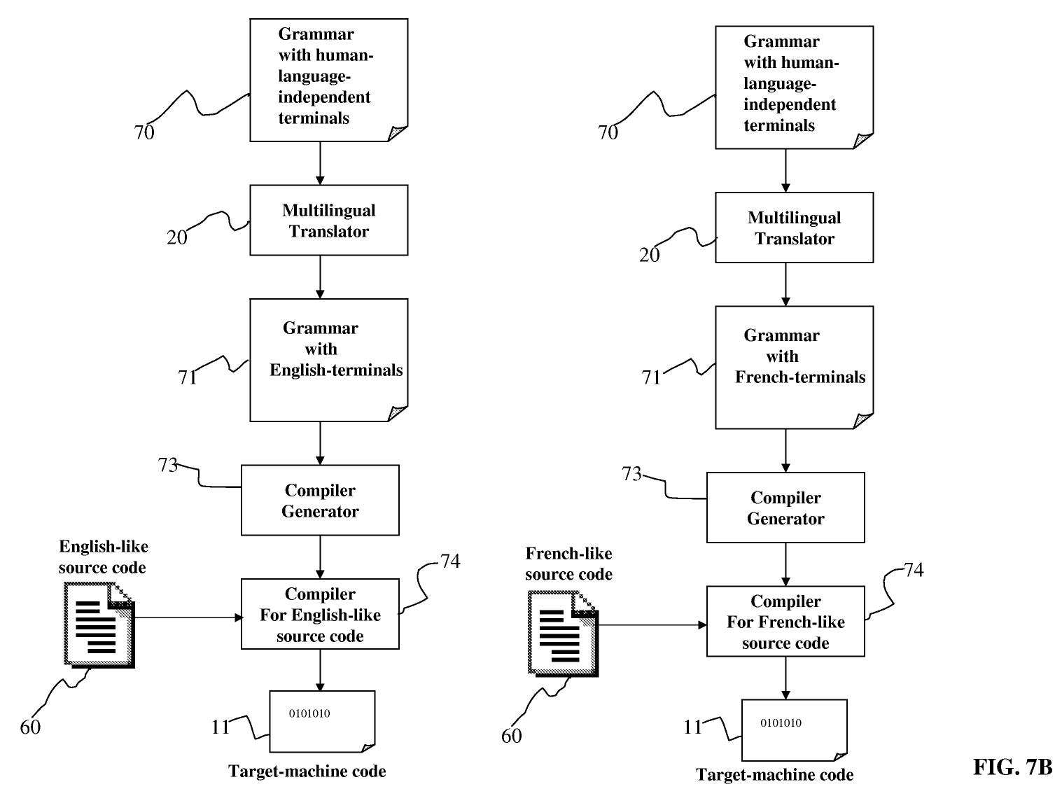

FIG. 7A illustrates an alternative design of the invention to support multilingual programming. The multilingual translator 20 is used to localize the grammar specification of a specific programming language 70 by replacing the terminals with specific human-language-like representation. The translator module 30 utilizes a language localization database 32, which stores the human-language-like and equivalent human-language-independent representations. In addition, the translator 30 utilizes a multilingual dictionary module 21 to translate identifiers and utilizes a multilingual phrase translator module 33 to translate phrases written by the programmer as comments and documentation of the source code.

FIG. 7B illustrates a usage of the alternative design of the invention to support multilingual programming. The multilingual translator 20 is used to localize the grammar specification of a specific programming language 70 by replacing the terminals with specific human-language-like representation. Next, the localized grammar is used to generate a compiler source code (parser and/or scanner) using a compiler generator. Those familiar in the art will immediately recognize how to do so. Next, the generated compiler code is converted to an executable that can process source code written in the previously chosen human-language-like representation. The generated compiler may access the multilingual translator 20 for localized compiler errors and warnings. FIG. 7B illustrates the described process with respect two human-language-like representations: English-like and French-like.

Among the improvements of the invention over the prior art:
The multilingual programming method does not require the programmer to learn a new human-language to be able to write computer programs.
The proposed method can be implemented with minimal changes to the existing compilers and languages. By making the human-language-independent representation identical to the English-like representation, the invention will become backward compatible with existing compilers/interpreters.
The invention could be implemented in any type of compiler: one-pass, threaded-code, incremental, stage, just-in-time, cross/retargetable, or parallel.
The invention could be implemented in high-level programming-languages as well as low-level programming-languages such as assembly. In addition, the source language could include low-level instructions such as moving values between the CPU registers.
The invention could be implemented for any human-language irrespective of it's type, for example: Austro-Asiatic, Afro-Asiatic, Niger-Congo, Sino-Tibetan, Sino-Tibetan, Tai-Kadai, or Oto-Manguean.
The invention provides the programmer with the ability to display errors and warnings in desired human-language-like representation, even if the source code was written in a different human-language-like representation.
The invention enables software developers whose native languages are different to work on the same project despite of native-language barriers.
The invention could be implemented for any programming-language type: procedural, functional, object oriented, message oriented, aspect oriented, structured, logic or fourth generation . . . .
The invention could be implemented for any programming-language execution mode: compiled, interpreted, or virtual machine based.
The invention could be implemented for any programming-language: general purpose or domain-specific.
The invention does not interfere with intermediate code optimization techniques, including in-line expansion, dead code elimination, constant propagation, loop transformation, register allocation or even auto parallelization.

There are many alternative ways that the invention could be implemented:
Any data structure (hash-table, indexed tree . . . ) could be used to store the mapping between language terminals/tokens and their translation. The same applies for errors and warnings.
Although programming languages has been used in describing the invention, other systems could be used. For example, drivers for plotters or other devices which have a command language of their own may be implemented in a similar multilingual fashion.
Using a special tag, meta-tag or language identifier, a source file could have more than one human-language-like representation (e.g. French-like and German-like). The multilingual translator 20 will scan for such markers and perform appropriate translation accordingly. This will enable developers whose native languages are different to work on the same source file.
Using a special tag, meta-tag or language identifier, a source file could have documentation written in more than one human-language-like representation.
The exemplary language localization database shows a one-to-one mapping between terminals and equivalent translations. This should not be considered a limitation on the invention. The mapping between terminals and equivalent translation could be one-to-one, one-to-many or many-to-one.
The multilingual translator could be implemented as part of a macro preprocessor instead of being a separate module.
The multilingual translator could be implemented as part of a compiler generator, for example: yacc, instead of being a separate module.
The multilingual translator could be implemented as part of an integrated development environment instead of being a separate module.
The multilingual translator could have software switches to control the translation of specific types of identifiers. For example, a programmer might disable translating function names while allowing other types of identifiers to be translated.
The multilingual translator could have a different software architecture; for example, by using component technology such as JavaBeans or COM.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

### REFERENCE NUMERALS USED IN THE DRAWINGS AND DESCRIPTION

1—Human-language-like source code
2—Lexical analyzer
3—Lexical tokens
4—Syntax/semantic analyzer
5—Parse tree
6—Intermediate code generator
7—Non-optimized intermediate code
8—Intermediate-code optimizer
9—Optimized intermediate code
10—Target code generator
11—Target machine code
11—Interpreter runtime
20—Multilingual translator
21—Human-language-independent source code
22—Errors and warnings
30—Translator module
31—Multilingual dictionary module
32—Language localization database
60—English-like source code
61—French-like source code
62—German-like source code
63—Dutch-like source code
65—English-like source code in W+
66—French-like source code in W+
67—Human-language-independent source code in W+
70—Grammar with human-language-independent terminals
71—Grammar with English terminals
72—Grammar with French terminals
73—Compiler Generator
74—Compiler for English-like source code
75—Compiler for French-like source code

1. A method for enabling multi-lingual programming using a programming language which has more than one native human language used in defining said programming language vocabulary, said method comprising:
parsing said input source code program;
examining each token during the parsing act and determining if the statement is part of the programming language vocabulary or part of program documentation;
if said token is part of said program language vocabulary, translating said token using a pre-defined vocabulary translation database;
if said token is part of said program documentation, translating said token using a pre-configured phrase translation module;
if said token is not part of said program language vocabulary or part of said program documentation, copying said token back to file unchanged;
generating a new target language source code.

2. A method as defined in claim 1 wherein a program developer can enable or disable the individual steps of said translations.

3. A method as defined in claim 1 wherein the native language used in writing the source code and documentation is specified using an XML meta tag defined in the source file.

4. A method as defined in claim 1 wherein the native language used in writing the source code and documentation is specified using meta property defined in the source file.

5. A method as defined in claim 1 wherein the native language used in writing the source code and documentation is specified using a file name or file extension.

6. A method as defined in claim 1 wherein identifiers that can not be translated by said translations are replaced by a pseudo random name and number generator.

7. A method as defined in claim 1 wherein said generated new source code is fed into a compiler to generate an executable version of said program.

8. A method as defined in claim 1 wherein translating said token, which is part of said program language vocabulary, is dependent on a safety test to ensure that no compile-time or run-time errors will be produced due to said translation.

9. A front end compiler system for supporting multi-lingual programming, said front end system comprising:
a translator module that converts an input source code program written in a specific native language vocabulary to either another native language vocabulary or to a native-language-independent representation;
a programming language vocabulary translation database, which stores a bi-directional mapping between said native language vocabulary for each supported human language and said native-language-independent representation.

10. The system of claim 9, further comprising:
a multilingual dictionary module

11. The system of claim 9, further comprising:
a multilingual phrase translator module to translate phrases embedded in the program source code by the programmer as documentation.

12. A computer system having at least a processor, accessible memory, and an accessible display, the computer system comprising;
means for storing a bi-directional mapping between a native language vocabulary for each supported human language and a native-language-independent representation.
means for translating an input source code program written in a specific native language vocabulary to either another native language vocabulary or to a native-language-independent representation.

13. The system of claim 12, further comprising:
means for feeding said program source code after said translation to a compiler to generate an executable version of said program.

14. A method for supporting multi-lingual programming, comprising:
defining a language grammar;
defining an equivalent set of native-language-dependent representation for each native language to be supported;
establishing a mapping between said native-language-dependent representation and said grammar.

15. A method as defined in claim 14 wherein said mapping is used to translate an input source code before feeding to a compiler built for said grammar.

16. A method as defined in claim 14 wherein said mapping is used to translate said grammar prior to constructing a compiler for said grammar.
